(19) United States
(12) Patent Application Publication
(10) Pub. No.: US 2015/0122311 A1
(43) Pub. Date: May 7, 2015

(54) SOLAR CELL MODULE

(71) Applicant: Mitsubishi Electric Corporation, Chiyoda-ku, Tokyo (JP)

(72) Inventors: Daisuke Echizenya, Tokyo (JP); Tetsuo Funakura, Tokyo (JP); Atsushi Michimori, Tokyo (JP); Hiroo Sakamoto, Tokyo (JP); Taisuke Sueda, Tokyo (JP); Hirotoshi Yonezawa, Tokyo (JP); Koji Shimasaki, Tokyo (JP)

(73) Assignee: Mitsubishi Electric Corporation, Chiyoda-ku, Tokyo (JP)

(21) Appl. No.: 14/403,831

(22) PCT Filed: Jun. 20, 2013
(86) PCT No.: PCT/JP2013/066960

§ 371 Date: Nov. 25, 2014

(30) Foreign Application Priority Data
Jun. 25, 2012 (JP) 2012-142074

(51) Int. Cl. H02S 30/10

(52) U.S. Cl. CPC H02S 30/10
USPC 136/251

(57) ABSTRACT

A solar cell module includes a solar cell panel including a light receiving surface, a rail-like holding member joined to a rear surface on the opposite side of the light receiving surface in the solar cell panel, the holding member reinforcing and holding the solar cell panel, an assisting member fixed to an end in a longitudinal direction of the holding member within the holding member, the assisting member assisting the holding of the solar cell panel by the holding member, and a screw that fixes the assisting member to the holding member. The assisting member has a bent shape bent in a direction opposed to the light receiving surface from a portion erected to the light receiving surface side through an edge of the solar panel from a position on the rear surface side fixed to the holding member by the fixing member.

### FIELD

The present invention relates to a solar cell module.

### BACKGROUND

A solar cell panel provided in a solar cell module has been configured by arranging power generation elements called cells on a translucent panel such as glass. As the solar cell module, there is, for example, a solar cell module to which a solar cell panel imparted with flexibility by omitting a relatively heavy reinforcing plate, for example, a glass plate or a metal plate on the opposite side of a light receiving surface is applied, and an outer edge section of the solar cell panel is surrounded by a framework-like frame. On the rear surface on the opposite side of the light receiving surface of the solar cell panel, a rib, both ends of which are fitted in the framework-like frame, is provided as a reinforcing member (see, for example, Patent Literature 1). Because the rib is applied instead of the reinforcing plate, a reduction in the weight of the solar cell module can be attained. Further, as the solar cell module, there is, for example, a solar cell module to which a solar cell panel in which the framework-like frame is omitted and a rail-like reinforcing member is bonded to the rear surface (see, for example, Patent Literature 2) is applied. Because the framework-like frame is omitted, the number of components of the solar cell module can be reduced. A further reduction in the weight of the solar cell module can be attained.

### CITATION LIST

### Patent Literature

Patent Literature 1: Japanese Patent Application Laid-Open No. 2006-269609
Patent Literature 2: Japanese Patent Application Laid-Open No. 2011-185030

### SUMMARY

### Technical Problem

In the configuration in which the solar cell panel is held by the reinforcing member bonded to the rear surface, when the bonding of the solar cell panel and the reinforcing member becomes fragile because of some unexpected cause, it is difficult to sufficiently support the solar cell panel. The solar cell module is required to prevent a fall-off of the solar cell panel even in a situation in which the solar cell panel comes off the reinforcing member.

The present invention has been devised in view of the above and it is an object of the present invention to obtain a solar cell module that can be reduced in weight and can prevent a fall-off of a solar cell panel.

### Solution to Problem

In order to solve the aforementioned problems, a solar cell module according to one aspect of the present invention is configured to include: a solar cell panel including a light receiving surface; a rail-like holding member joined to a rear surface on the opposite side of the light receiving surface in the solar cell panel, the holding member reinforcing and holding the solar cell panel; an assisting member fixed to an end in a longitudinal direction of the holding member within the holding member, the assisting member assisting the holding of the solar cell panel by the holding member; and a fixing member that fixes the assisting member to the holding member, wherein the assisting member has a bent shape bent in a direction opposed to the light receiving surface from a portion erected to the light receiving surface side through an edge of the solar panel from a position on the rear surface side fixed to the holding member by the fixing member.

### Advantageous Effects of Invention

According to the present invention, the solar cell panel is held and reinforced by the rail-like holding member instead of a heavy reinforcing plate. Therefore, a reduction in the weight of the solar cell module can be attained. The assisting member is formed in the bent shape and provided at the end of the holding member. Therefore, the assisting member can play a role of resisting a fall-off of the solar cell panel. Because the solar cell module is applied with the assisting member, even when it is difficult to hold the solar cell panel with the holding member, the solar cell module can prevent a fall-off of the solar cell panel. Consequently, there is an effect that the solar cell module can be reduced in weight and can prevent a fall-off of the solar cell panel.

### BRIEF DESCRIPTION OF DRAWINGS

FIG. 1 is a perspective view on the rear surface side of a solar cell module according to a first embodiment of the present invention.

FIG. 2 is a schematic diagram of a sectional configuration of a solar cell panel.

FIG. 3 is a perspective view of the configuration of an end of a holding member and the vicinity of the end.

FIG. 4 is a perspective view of an assisting member.

FIG. 5 is a perspective view of the end of the holding member shown with the assisting member and the solar cell panel removed.

FIG. 6 is a perspective view of the solar cell module fixed to a rack.

FIG. 7 is a side view of the configuration of the end of the holding member and the vicinity of the end.

FIG. 8 is a perspective view of a modification of the assisting member.

FIG. 9 is a side view of an application example of the assisting member shown in FIG. 8.

FIG. 10 is a perspective view on the rear surface side of a solar cell module according to a second embodiment of the present invention.

FIG. 11 is a perspective view of the configuration of an end of a holding member and the vicinity of the end.

FIG. 12 is a perspective view of an assisting member.

FIG. 13 is a side view of the configuration of an end of a holding member and the vicinity of the end in a solar cell module according to a third embodiment of the present invention.

FIG. 14 is a side view of the configuration of an end of a holding member and the vicinity of the end in a solar cell module according to a fourth embodiment of the present invention.

FIG. 15 is a side view of the configuration of an end of a holding member and the vicinity of the end in a solar cell module according to a fifth embodiment of the present invention.

FIG. 16 is a side view of the configuration of an end of a holding member and the vicinity of the end in a solar cell module according to a sixth embodiment of the present invention.

### DESCRIPTION OF EMBODIMENTS

Embodiments of a solar cell module according to the present invention are explained in detail below with reference to the drawings. Note that the present invention is not limited to the following description and can be changed as appropriate without departing from the spirit of the present invention. In the drawing referred to below, for easiness of understanding, scales of members are sometimes different from actual scales. The same applies among the drawings.

### First Embodiment

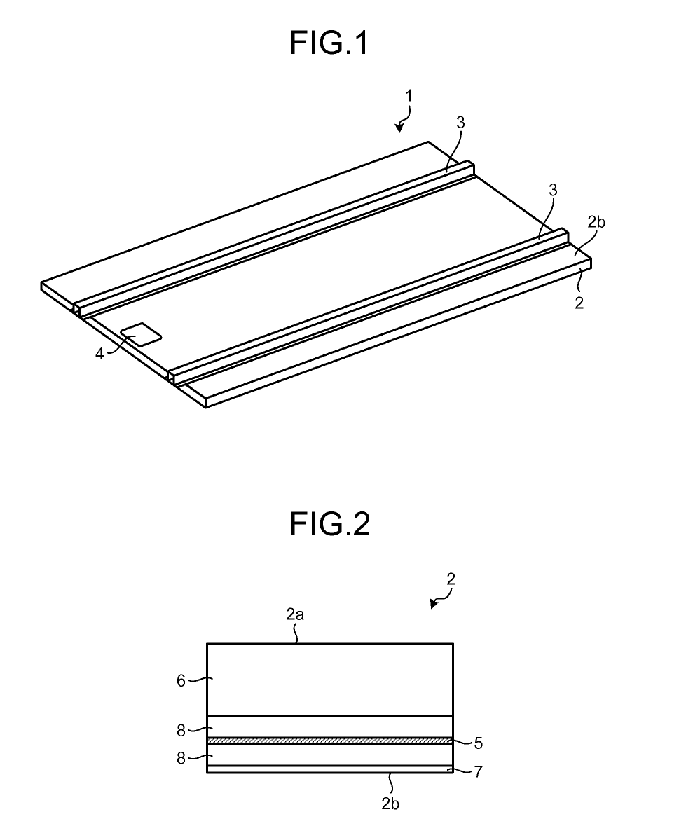

FIG. 1 is a perspective view on the rear surface side of a solar cell module according to a first embodiment of the present invention. A solar cell module 1 includes a solar cell panel 2 and rail-like holding members 3. The holding members 3 reinforce and hold the solar cell panel 2 replacing for a reinforcing plate for increasing the rigidity of a panel and a framework-like frame that covers the entire edge of the panel. A terminal box 4 houses a terminal for connecting an electric wire.

FIG. 2 is a schematic diagram of a sectional configuration of the solar cell panel. The solar cell panel 2 includes a solar cell 5, a translucent panel 6, a back film 7, and a sealing material 8. The solar cell panel 2 is, for example, a crystal-based solar cell panel in which the solar cell 5 is laminated by the sealing material 8. The solar cell 5 has a photoelectric conversion function. The sealing material 8 seals both surfaces of the solar cell 5. The sealing material 8 is, for example, ethylene-vinyl acetate copolymer resin (EVA).

The translucent panel 6 forms a light receiving surface 2a of the solar cell panel 2. The translucent panel 6 is a plate of a translucent member, for example, thermally tempered glass. The back film 7 is provided on a rear surface 2b side on the opposite side of the light receiving surface 2a in the solar cell panel 2. Note that, besides being the crystal-based solar cell panel, the solar cell panel 2 can be a thin-film solar cell panel in which a power generation layer is formed directly on glass.

The holding members 3 shown in FIG. 1 are joined to the rear surface 2b of the solar cell panel 2. Two holding members 3 are provided for one solar cell panel 2. In the two holding members 3, a direction parallel to two sides opposed to each other in a rectangle formed by the solar cell panel 2 is defined as a longitudinal direction, and further, the two holding members 3 are respectively arranged in the positions apart from the two sides.

The holding members 3 are, for example, cylindrical bodies. In the holding members 3, one surface of each of the cylindrical bodies is joined to the rear surface 2b of the solar cell panel 2. The holding members 3 are formed of, for example, an aluminum material. The holding members 3 are formed of the aluminum material resistive against oxidation to make it possible to suppress deterioration due to rust.

The holding members 3 are manufactured by, for example, extrusion molding. By using the extrusion molding, the holding members 3 that are inexpensive and high strength can be prepared. The holding members 3 are manufactured by the extrusion molding with cross sections perpendicular to the longitudinal direction formed in the same shape in all positions in the longitudinal direction.

For example, an adhesive is used for the joining of the solar cell panel 2 and the holding members 3. The solar cell panel 2 and the holding members 3 are generally made of different materials and have different thermal deformation amounts. Therefore, a load occurs in bonded portions of the solar cell panel 2 and the holding members 3. To reduce the load in the bonded portions, the adhesive is preferably an adhesive having flexibility. Because the solar cell module 1 is used for a long period such as ten or more years, the adhesive is desirably an adhesive that has less aged deterioration and is stable. From such viewpoints, for example, a silicon-based adhesive is used for the adhesive. Note that, for the joining of the solar cell panel 2 and the holding members 3, besides the adhesive, for example, a double sided tape can be used.

The width of bonding surfaces in the holding members 3 is set to, for example, 20 millimeters. The area of the bonding surfaces of the holding members 3 with the rear surface 2b of the solar cell panel 2 is specified according to bonding strength and can be changed as appropriate according to a bonding method. The width of the bonding surfaces in the holding members 3 is set between, for example, about 20 millimeters and the 60 millimeters. To enable sufficient reinforcement of the solar cell panel 2, the height in a direction perpendicular to the bonding surfaces of the holding members 3 is set between, for example, about 20 millimeters and 60 millimeters.

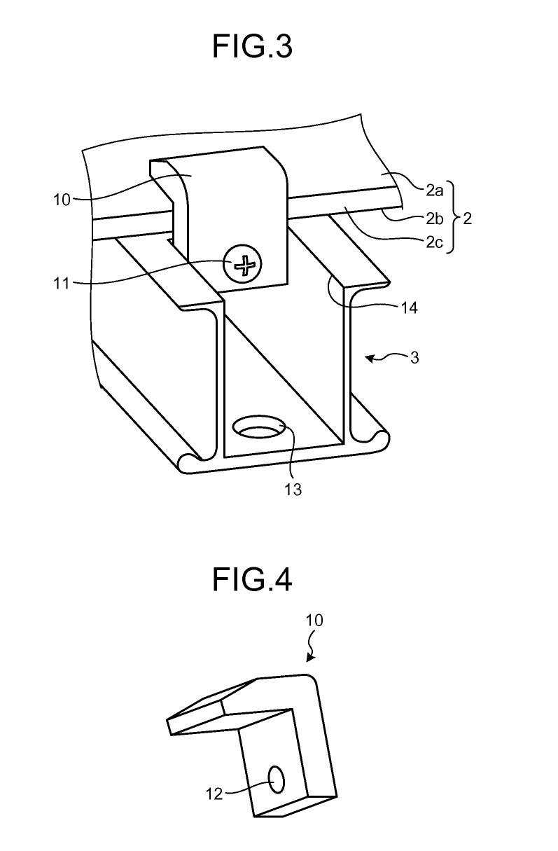

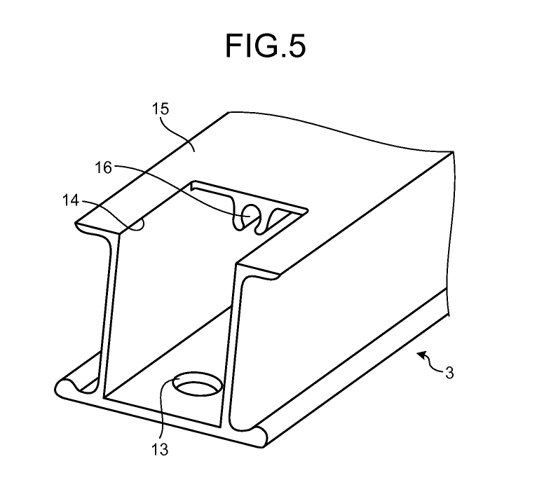

FIG. 3 is a perspective view of the configuration of an end of the holding member and the vicinity of the end. FIG. 4 is a perspective view of an assisting member. FIG. 5 is a perspective view of the end of the holding member shown with the assisting member and the solar cell panel removed. An assisting member 10 is fixed to an end in the longitudinal direction of the holding member 3 in the holding member 3. The assisting member 10 assists holding of the solar cell panel 2 by the holding member 3. A screw 11 is a fixing member that fixes the assisting member 10 to the holding member 3. The screw 11 is tightened to pierce through a screw hole 12 formed in the assisting member 10 until the distal end of the screw 11 reaches the inside of a screw hole 16 of the holding member 3.

The assisting member 10 is formed in a bent shape with a plate material bent at substantially a right angle. The assisting member 10 has a bent shape bent in a direction opposed to the light receiving surface 2a from a portion erected to the light receiving surface 2a side through an edge 2c of the solar cell panel 2 from a position on the rear surface 2b side fixed to the holding member 3 by the screw 11.

A bonding layer formed of an adhesive or an adhesive tape for bonding the rear surface 2b and a bonding surface 15 of the holding member 3 is not shown in the figure. The thickness of the bonding layer greatly changes according to a bonding method. To enable the assisting member 10 to assist the holding of the solar cell panel 2 over a long period, the assisting member 10 is formed of metal resistive against corrosion, for example, aluminum, stainless steel, or a galvanized steel sheet. The assisting member 10 is formed, for example, with a length of about 20 millimeters with respect to thickness of about 10 millimeters. Note that the shape and the dimension of the assisting member 10 are arbitrary.

The screw hole 16 is formed on the inner surface on the opposite side of the bonding surface 15 in a tabular portion including the bonding surface 15 and forming the holding member 3. In such a tabular portion, a cutout section 14 formed by cutting out a section from the end of the holding member 3 to the position of the edge 2c of the solar cell panel 2 is formed. The assisting member 10 is fixed by inserting the screw 11 into the screw holes 12 and 16 in a state in which the assisting member 10 is opposed to the edge 2c of the solar cell panel 2 in the cutout section 14.

A bolt hole 13 is formed in a tabular portion opposed to the tabular portion including the bonding surface 15 within the holding member 3. A bolt (not shown in the figure) for fixing the holding member 3 to a rack, which supports the solar cell panel 2, is inserted through the bolt hole 13.

A reduction in the weight of the solar cell module 1 can be attained by holding and reinforcing the solar cell panel 2 with the rail-like holding members 3 instead of a heavy reinforcing plate. The number of components of the solar cell module 1 can be reduced and a further reduction in the weight of the solar cell module 1 can be attained by omitting the framework-like frame. The holding members 3 bonded to the rear surface 2b of the solar cell panel 2 are fixed to the rack, whereby the solar cell module 1 is supported by the rack.

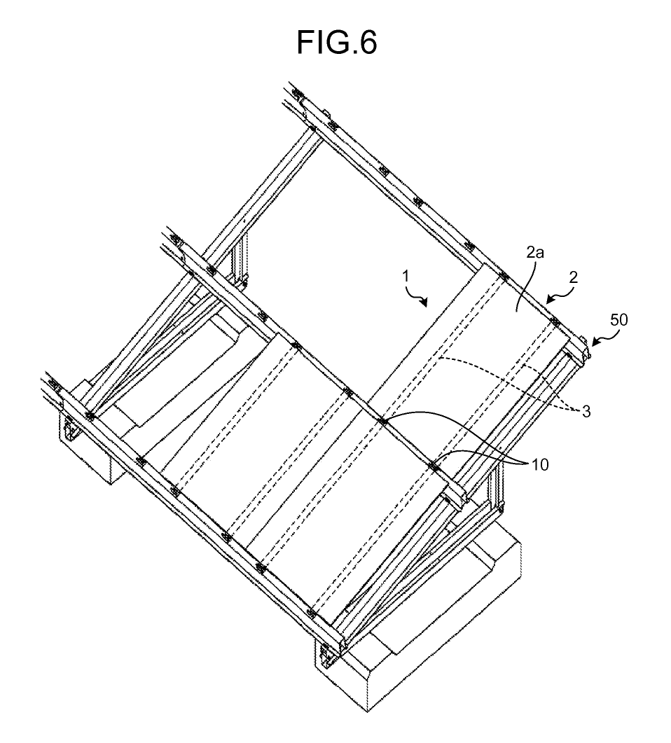

FIG. 6 is a perspective view of the solar cell module fixed to the rack. The solar cell module 1 is fixed to a rack 50 via the holding members 3. The rack 50 is set on the ground, a roof, or the like. Detailed explanation concerning the configuration of the rack 50 and a configuration for fixing the holding members 3 to the rack 50 is omitted.

Under a normal environment of use of the solar cell module 1, the bonding of the rear surface 2b of the solar cell panel 2 and the holding members 3 can be sufficiently maintained. However, when some unexpected situation occurs, such bonding can become fragile. The unexpected situation indicates an incidence that cannot normally be assumed, for example, an incidence in which chemical substances having characteristics of deteriorating the adhesive reach the solar cell module 1 because of an accident in a neighboring chemical plant. When the adhesive made of resin or the like is exposed to high temperature because of a fire or the like, an adhesive force greatly decreases because of denaturation.

When the solar cell panel 2 comes off the holding members 3 because of such an unexpected situation, the assisting member 10 formed in the bent shape receives the solar cell panel 2 that moves in the longitudinal direction of the holding members 3. The assisting member 10 prevents the solar cell panel 2 from slipping off from the holding members 3. The assisting member 10 functions as a backup and prevents, when the solar cell panel 2 comes off the holding members 3, the slip-off of the solar cell panel 2 to play a function of assisting a holding function of the solar cell panel 2 by the holding members 3 and resisting a fall-off of the solar cell panel 2. Consequently, there is an effect that the solar cell module 1 can be reduced in weight and can prevent the fall-off of the solar cell panel 2.

In the solar cell module 1, deformation of the solar cell panel 2 due to wind pressure is prevented by the holding members 3. Large deformation of the solar cell panel 2 causes deterioration in power generation efficiency due to breakage of the laminated solar cell 5, wires, and the like. In JIS, IEC, and the like, there are authentication standards for evaluating deterioration in power generation efficiency with respect to a load that simulates the wind pressure. The structure of the solar cell module 1 is designed with reference to the power generation efficiency.

The solar cell module 1 according to this embodiment is formed in a rigid configuration, which resists the wind pressure, by providing the holding members 3. By providing the assisting member 10, the fall-off of the solar cell panel 2 is prevented in a situation in which the solar cell panel 2 comes off the holding members 3. Note that a solar power generation system including the solar cell module 1 may include a monitoring system capable of quickly detecting large deformation of the solar cell panel 2 according to the deterioration in the power generation efficiency due to breakage of the solar cell 5, the wires, and the like.

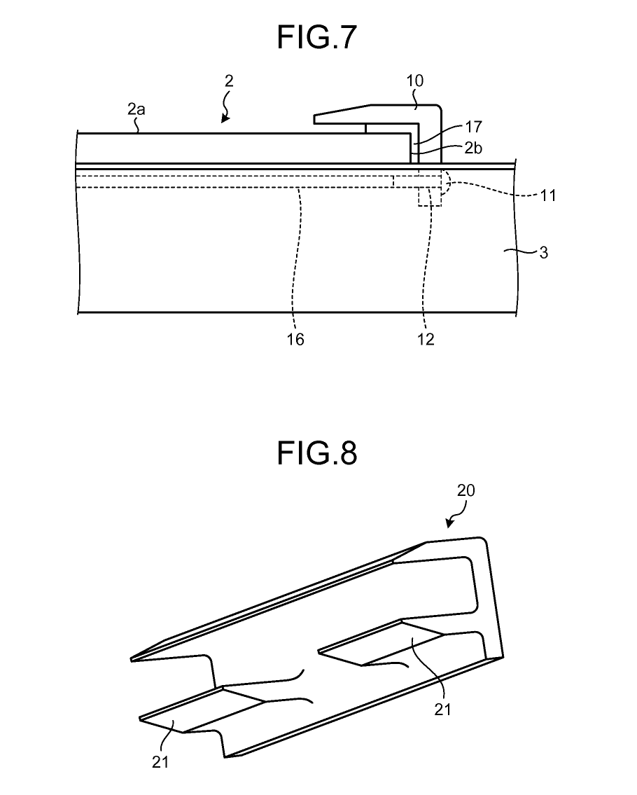

FIG. 7 is a side view of the configuration of the end of the holding member and the vicinity of the end. In a portion other than the cutout section 14 in the holding member 3, a cross section perpendicular to the longitudinal direction is formed in the same shape including the shape of the screw hole 16 in all positions in the longitudinal direction. Because the holding member 3 including the screw hole 16 is manufactured by the extrusion molding, the number of manufacturing processes of the solar cell module 1 can be reduced compared with when additional machining for forming the screw hole 16 in the holding member 3 is required.

A bonding layer 17 bonds the assisting member 10 and the solar cell panel 2. For the bonding layer 17, for example, an adhesive or a double sided tape is used. Because the bonding layer 17 is interposed, the assisting member 10 and the solar cell panel 2 are set not to be in direct contact with each other. The assisting member 10 is fixed to be spaced apart from the light receiving surface 2a of the solar cell panel 2.

Only when the solar cell panel 2 peels off the holding member 3 because of some cause and stress in a direction separating from the holding member 3 acts on the solar cell panel 2 for the first time, the assisting member 10 comes into contact with the light receiving surface 2a of the solar cell panel 2. The assisting member 10 is prevented from coming into contact with the solar cell panel 2 except in a situation in which the solar cell panel 2 peels off the holding member 3. Therefore, it is possible to suppress breakage of the solar cell panel 2 due to contact of the assisting member 10 in processes of manufacturing, delivery, and setting of the solar cell module 1.

In situations other than the situation in which the solar cell panel 2 peels off the holding member 3, the assisting member 10 plays a function of holding the solar cell panel 2 via the bonding layer 17 and assisting the holding of the solar cell panel 2 by the holding member 3. Note that, in the solar cell module 1, even if the bonding layer 17 between the solar cell panel 2 and the assisting member 10 is omitted, it is possible to obtain an effect of preventing fall-off of the solar cell panel 2 when the solar cell panel 2 comes off the holding member 3.

Note that a configuration is also possible in which, instead of the assisting member 10, a stopper that prevents a slip-off of the solar cell panel 2 is provided in the rack 50 that supports the solar cell module 1. However, because of the configuration of the rack 50, it is sometimes difficult to arrange the stopper in the rack 50. As in this embodiment, by providing the assisting member 10 in the holding member 3 of the solar cell module 1, it is possible to prevent the fall-off of the solar cell panel 2 irrespective of the configuration of the rack 50.

Because the solar cell module 1 is connected by wires, even if the solar cell panel 2 falls off, the movement of the solar cell panel 2 is limited in a range of the length of the wires. The assisting member 10 can greatly suppress a moving range of the solar cell panel 2 with respect to the range of the length of the wire. According to this embodiment, because the moving range of the solar cell panel 2 is suppressed by the assisting member 10, it is possible to prevent collision of the solar cell panel 2 and a structure around the solar cell panel 2 and reduce breakage of the solar cell panel 2 and the structure around the solar cell panel 2.

The translucent panel 6 (see FIG. 2) forming the solar cell panel 2 may be formed with strength for allowing the solar cell panel 2 to be destroyed by stress weaker than stress applied when the holding member 3 is peeled from the rear surface 2b of the solar cell panel 2 and the solar cell panel 2 comes off the assisting member 10. When the holding member 3 peels off the rear surface 2b and large stress is applied to the contact portion of the solar cell panel 2 and the assisting member 10, before the assisting member 10 is destroyed, the entire translucent panel 6 comes apart into fragments equal to or smaller than, for example, 30 millimeters because of stress balance.

When the holding member 3 is peeled from the rear surface 2b and large wind pressure is applied to the solar cell panel 2, the solar cell panel 2 is destroyed to be light and small pieces and falls down before being blown off. Consequently, it is possible to suppress an adverse effect on the surroundings caused by the blow-off of the solar cell panel 2 before the coming-apart. When the solar cell module 1 is set in a place where buildings are present in the neighborhood, for example, an urban area or a residential area, it is useful to destroy the solar cell panel 2 before the solar cell panel 2 comes off.

Note that the translucent panel 6 can be chemically tempered glass besides the thermally tempered glass. By using chemically tempered glass in which residual stress is generated to an intermediate layer of glass, it is possible to divide the translucent panel 6 into light and small pieces. Selection of the glass is desirably performed by directly destroying the glass and checking the size of fragments.

For the solar cell module 1, structure design to form the assisting member 10 with sufficient strength and prevent the solar cell panel 2 from slipping off is designed. To obtain the effects of the present invention, for example, in a state in which the assisting member 10 is not bonded to the solar cell panel 2, a form of destruction of the solar cell module 1 is repeatedly checked by a test similar to a hydrostatic test specified by JIS or the like to determine the structure of the solar cell module 1. By performing the test while changing the design of the solar cell module 1, it is checked to which type of the following destructions, namely a destruction of the solar cell panel 2, a destruction of a structure including the assisting member 10 for prevention of coming-off of the solar cell panel 2, and a coming-off of the solar cell panel 2 from the solar cell panel 2, the destruction of the solar cell module 1 corresponds.

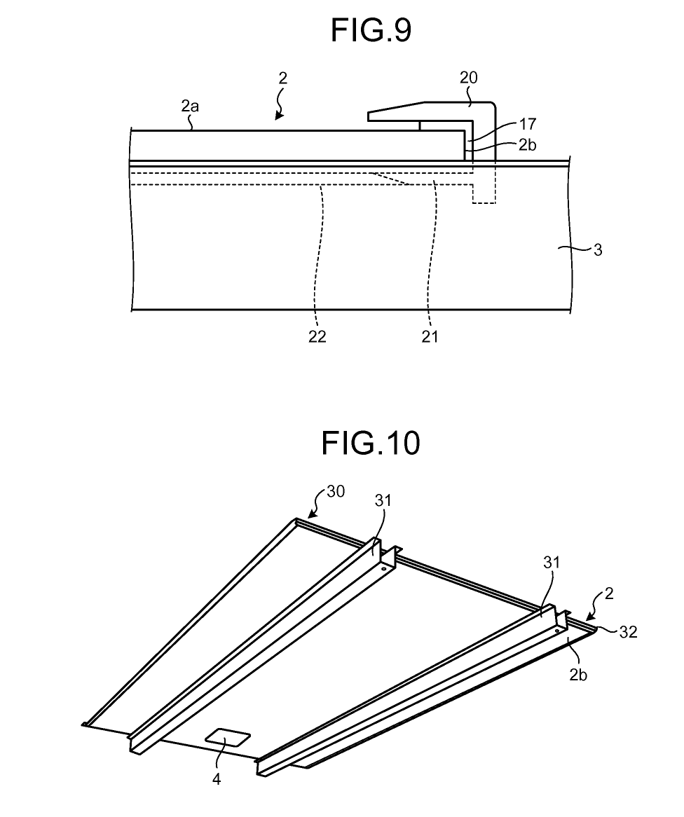

FIG. 8 is a perspective view of a modification of the assisting member. FIG. 9 is a side view of an application example of the assisting member shown in FIG. 8. An assisting member 20 includes two inserting sections 21. The inserting sections 21 are formed to be insertable into an insertion hole 22 formed in the holding member 3. The inserting sections 21 function as fixing members that fix the assisting member 20 to the holding member 3.

The assisting member 20 has a bent shape bent in a direction opposed to the light receiving surface 2a from a portion erected to the light receiving surface 2a side through the edge 2c of the solar cell panel 2 from a position on the rear surface 2b side fixed to the holding member 3 by the inserting sections 21. To enable the assisting member 20 to assist the holding of the solar cell panel 2 over a long period, the assisting member 20 is formed of metal resistive against corrosion, for example, aluminum, stainless steel, or a galvanized steel sheet. The assisting member 20 is formed, for example, with a length of about 100 millimeters with respect to thickness of about 3 millimeters. Note that the shape and the dimension of the assisting member 20 are arbitrary.

The inserting sections 21 are configured by projecting parts of the assisting member 20. Note that the assisting member 20 is not limited to a configuration in which the two inserting sections 21 are arranged in parallel. The number and an arrangement for of the inserting sections 21 formed in the assisting member 20 can be changed as appropriate.

The insertion hole 22 is formed on the inner surface on the opposite side of the bonding surface 15 in the tabular portion including the bonding surface 15 (see FIG. 5) and forming the holding member 3. The assisting member 20 is fixed by inserting the inserting sections 21 into the insertion hole 22 in a state in which the assisting member 20 is opposed to the edge 2c of the solar cell panel 2 in the cutout section 14 (see FIG. 3).

In a portion other than the cutout section 14 in the holding member 3, a cross section perpendicular to the longitudinal direction is formed in the same shape including the shape of the insertion hole 22 in all positions in the longitudinal direction. Because the holding member 3 including the insertion hole 22 is manufactured by the extrusion molding, the number of manufacturing processes of the solar cell module 1 can be reduced compared with when additional machining for forming the insertion hole 22 in the holding member 3 is required.

The assisting member 20 is fixed to the holding member 3 by pressing the inserting sections 21 into the insertion hole 22. Note that the inserting sections 21 may be fixed to the insertion hole 22 through additional machining such as bonding, welding, or caulking. The assisting member 20 can be fixed to the holding member 3 by simple machining such as bonding, welding, or caulking in a state in which the inserting sections 21 are pressed into the insertion hole 22 or the inserting sections 21 are inserted into the insertion hole 22. When the assisting member 20 in this modification is applied as well, the solar cell module 1 can be reduced in weight and can prevent fall-off of the solar cell panel 2.

### Second Embodiment

FIG. 10 is a perspective view on the rear surface side of a solar cell module according to a second embodiment of the present invention. Components same as the components in the first embodiment are denoted by the same reference numerals and signs and redundant explanation of the components is omitted as appropriate.

A solar cell module 30 includes the solar cell panel 2 and rail-like holding members 31. The rail-like holding members 31 reinforce and hold the solar cell panel 2, replacing for a reinforcing plate for increasing the rigidity of a panel. An edge protector 32 covers the entire edge of the solar cell panel 2. Note that the edge protector 32 can be omitted in the solar cell module 30.

The holding members 31 are joined to the rear surface 2b of the solar cell panel 2. Two holding members 31 are provided for one solar cell panel 2. In the two holding members 31, a direction parallel to two sides opposed to each other in a rectangle formed by the solar cell panel 2 is a longitudinal direction. The two holding members 31 are respectively arranged in positions apart from the two sides.

Each of the holding members 31 includes, for example, a rail-like recess. In each of the holding members 31, the surface forming an edge of the recess is joined to the rear surface 2b of the solar cell panel 2. Each of the holding members 31 is formed by bending, for example, a galvanized steel sheet or an aluminum sheet. When the holding members 31 is formed using the galvanized steel sheet, the holding member 31 can be formed inexpensively compared with a case in which the aluminum sheet is used.

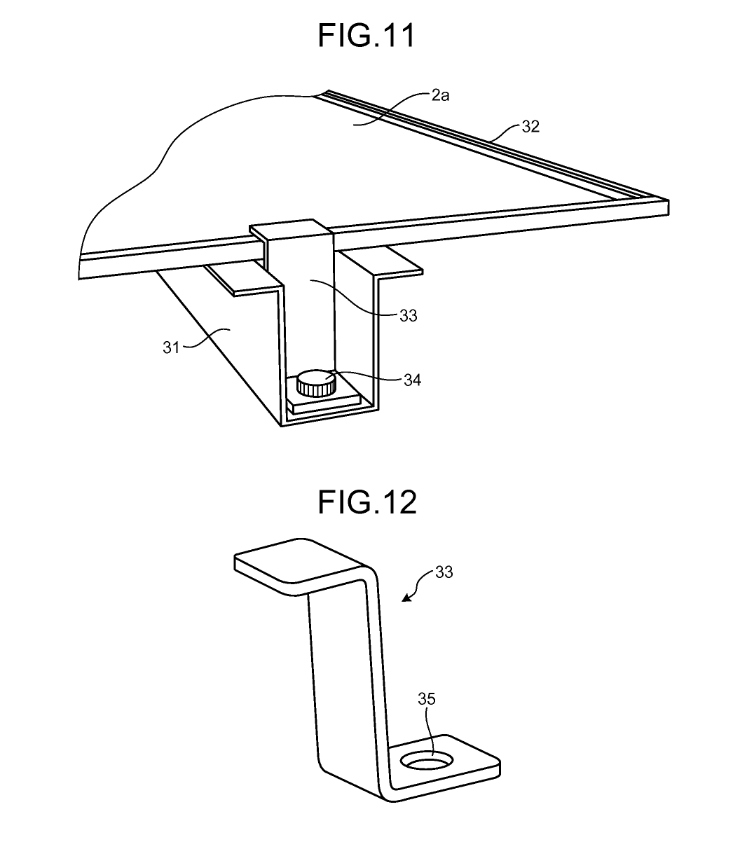

FIG. 11 is a perspective view of the configuration of an end of the holding member and the vicinity of the end. FIG. 12 is a perspective view of an assisting member. An assisting member 33 is fixed to an end in the longitudinal direction of the holding member 31 in the holding member 31. The assisting member 33 assists the holding of the solar cell panel 2 by the holding member 31.

The assisting member 33 is formed in a bent shape with a plate material bent at a substantially right angle in two places. A bolt 34 is a fixing member that fixes the assisting member 33 to the holding member 31. One end of the assisting member 33 is fixed to a bottom surface section forming the recess in the holding member 31 by the bolt 34. The assisting member 33 is bent to the edge 2c (see FIG. 3) of the solar cell panel 2 from a place fixed by the bolt 34. The assisting member 33 is further bent in a direction opposed to the light receiving surface 2a from a portion erected to the light receiving surface 2a side through the edge 2c of the solar cell panel 2 from a position on the rear surface 2b side fixed to the holding member 31 by the bolt 34. In the solar cell module 30, the bonding layer 17 (see FIG. 7) that bonds the assisting member 33 and the edge protector 32 or the solar cell panel 2 can be provided.

In the assisting member 33, a bolt hole 35 through which the bolt 34 is inserted is formed. In the bottom surface section forming the recess in the holding member 31, a bolt hole (not shown in the figure) is formed in a position coinciding with the bolt hole 35 of the assisting member 33. The bolt 34 is tightened to pierce through the bolt hole 35 of the assisting member 33 and a bolt hole of the holding member 31 until the distal end of the bolt 34 reaches the inside of a member forming the rack 50 (see FIG. 6) that supports the solar cell module 30. The bolt 34 collectively fixes the holding member 31 and the assisting member 33 to the rack 50.

To suppress breakage of the holding member 31 due to concentration of a load on a tightening portion of the bolt 34, the holding member 31 is formed with thickness equal to or larger than, for example, 2 millimeters. Alternatively, instead of forming the holding member 31 with the thickness, a facing ring such as a washer with a certain degree of thickness can be sandwiched in the tightening portion of the bolt 34. When the facing ring is used, although the number of components increases, the holding member 31 can be reduced in thickness. The solar cell module 30 can be reduced in weight and material costs of the solar cell module 30 can be reduced by the reduction in the thickness of the holding member 31.

The assisting member 33 is formed, for example, thicker than the holding member 31 to resist a fall-off of the solar cell panel 2 when the holding member 31 is peeled off the rear surface 2b. The assisting member 33 also plays a function of a facing ring that reduces concentration of a load on the holding member 31 by the bolt 34.

As in the first embodiment, the solar cell module 30 in this embodiment can be reduced in weight and can prevent the fall-off of the solar cell panel 2. Further, in the solar cell module 30 in this embodiment, by collectively fixing the holding member 31 and the assisting member 33 to the rack 50, the number of components can be reduced compared with when each of the holding member 31 and the assisting member 33 is separately fixed. In the solar cell module 30, the concentration of the load on the holding member 31 by the bolt 34 can be reduced by the assisting member 33. In the solar cell module 30, by bonding the assisting member 33 to the edge protector 32 or the solar cell panel 2 in advance, work for incorporating components can be simplified.

### Third Embodiment

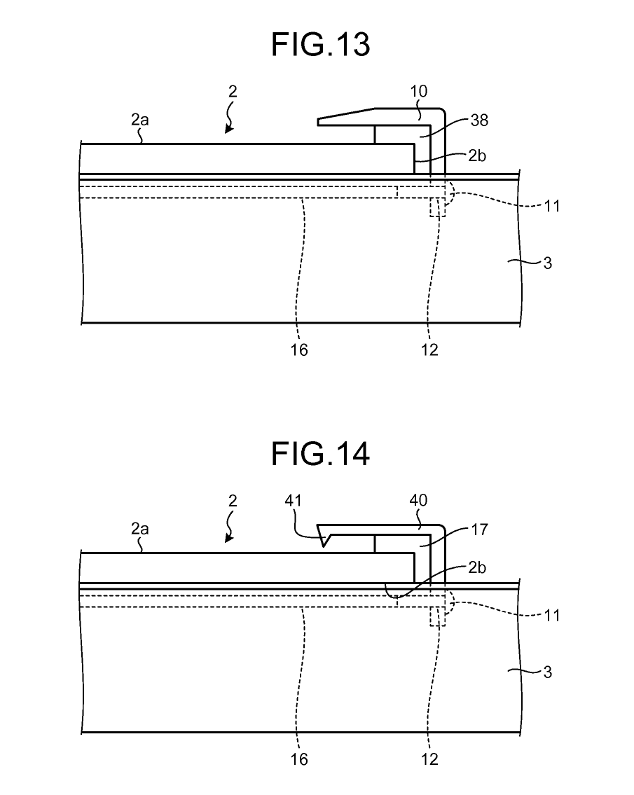

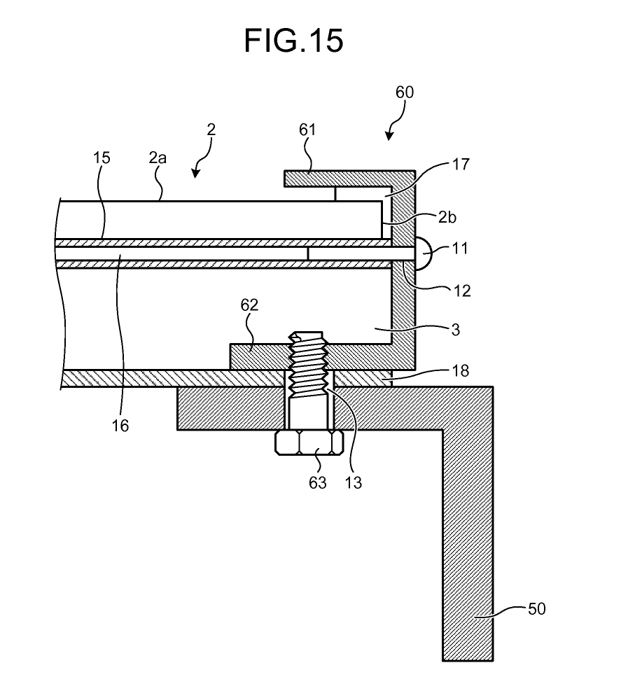

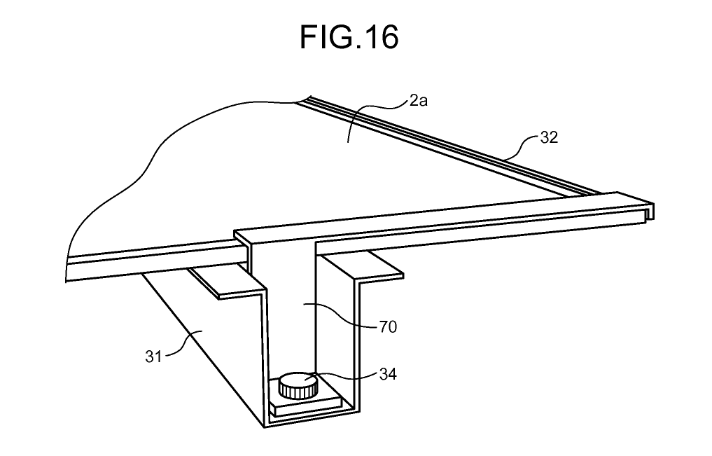

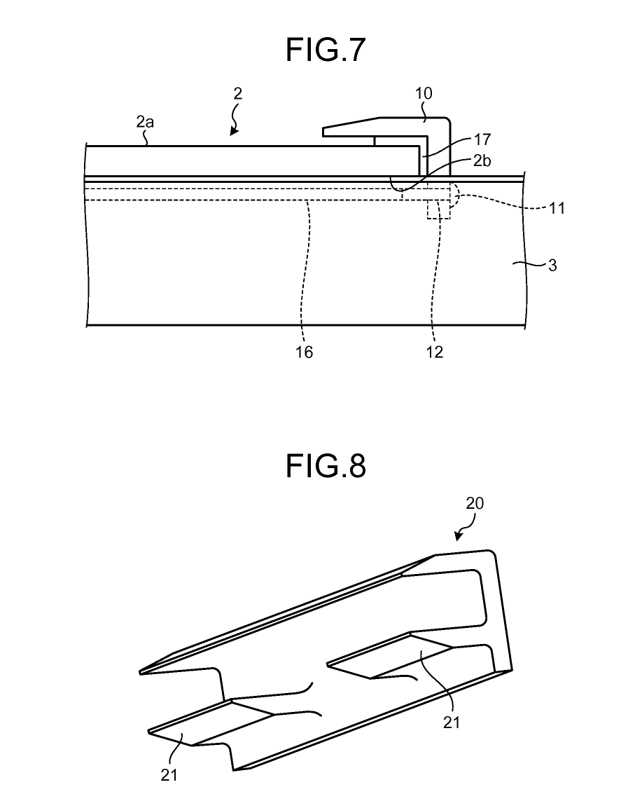

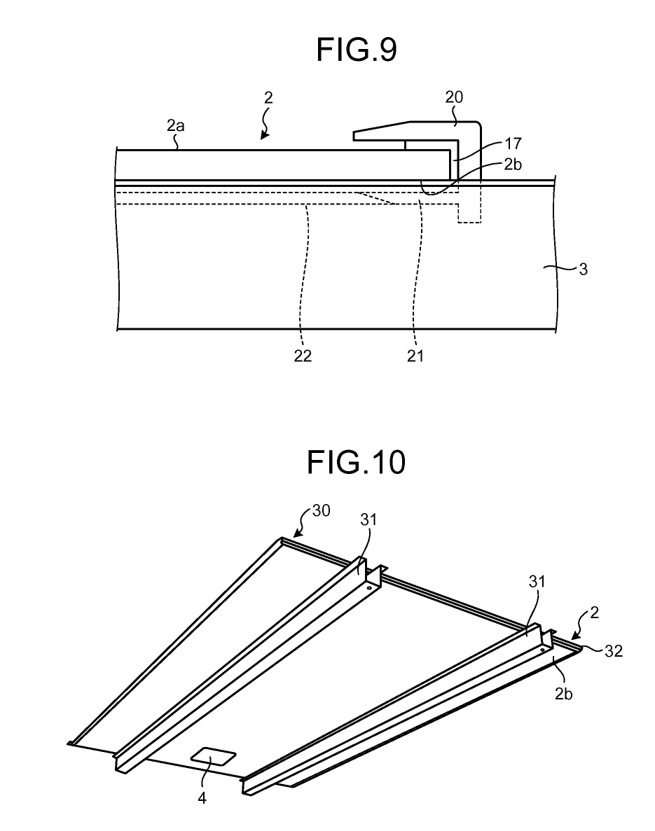

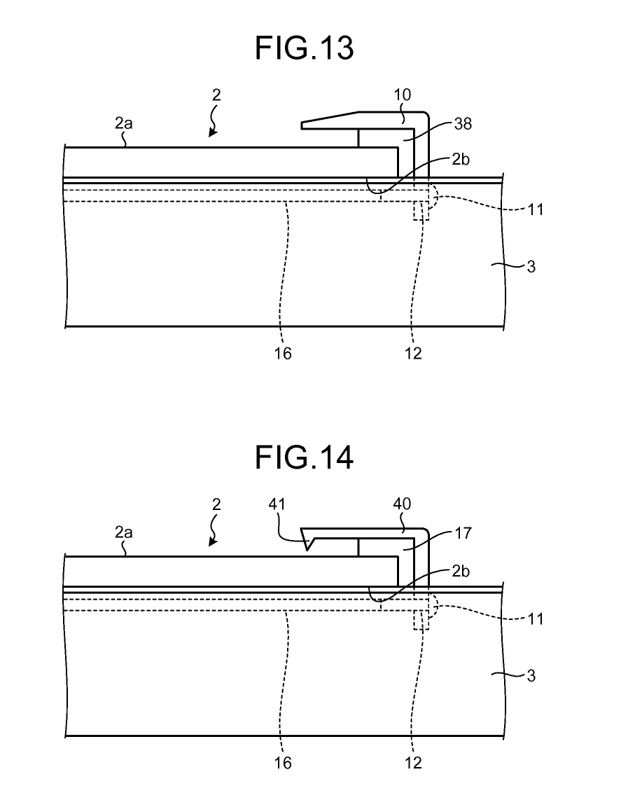

FIG. 13 is a side view of the configuration of an end of a holding member and the vicinity of the end in a solar cell module according to the third embodiment of the present invention. Components same as the components in the first embodiment are denoted by the same reference numerals and signs and redundant explanation of the components is omitted as appropriate.

A spacer 38 is set between the assisting member 10 and the solar cell panel 2. The spacer 38 is formed of a member having high flexibility with respect to the glass member forming the solar cell panel 2. The material of the spacer 38 is, for example, a resin material such as rubber or plastics or a soft metal material such as tin.

The spacer 38 is provided to be compression bonded to the assisting member 10 and the solar cell panel 2. The spacer 38 is tolerance-designed to be in a compression loaded state in a state in which the spacer 38 is set between the assisting member 10 and the solar cell panel 2. The tolerance design for setting the spacer 38 in the compression loaded state means increasing the spacer 38 in thickness by a tolerance with respect to a gap between the assisting member 10 and the solar cell panel 2. The spacer 38 is designed to have thickness larger than the gap between the assisting member 10 and the solar cell panel 2 before the spacer 38 is sandwiched by the assisting member 10 and the solar cell panel 2.

Consequently, the spacer 38 sufficiently adheres to both of the assisting member 10 and the solar cell panel 2 with a repulsive force that resists compression by the assisting member 10 and the solar cell panel 2. The spacer 38 requires about 0.1 millimeter to 0.5 millimeter as a tolerance that can be designed in normal manufacturing. It is effective to form the spacer 38 in thickness of, for example, about 0.5 millimeters to 2 millimeters such that the spacer 38 is sufficiently compressed by the tolerance.

When the bonging of the holding member 3 and the solar cell panel 2 is weakened by an unexpected situation and stress in a direction separating from the holding member 3 acts on the solar cell panel 2, the spacer 38 generates a frictional force with the repulsive force. The spacer 38 prevents a slip-off of solar cell panel 2 with the frictional force on the solar cell panel 2. As in the first embodiment, the solar cell module in this embodiment can be reduced in weight and can prevent a fall-off of the solar cell panel 2.

When the assisting member 10 and the solar cell panel 2 are bonded, if a situation in which the bonding of the solar cell panel 2 and the holding member 3 is made fragile occurs, the bonding of the assisting member 10 and the solar cell panel 2 can also be made fragile. As in this embodiment, it is effective, as backup for preventing a slip-off of the solar cell panel 2 when the solar cell panel 2 comes off the holding member 3, to adopt, as a method different from the bonding, a structure for holding the solar cell panel 2 with the repulsive force of the spacer 38. In the case of this embodiment, it is easy to detach the solar cell panel 2 and the assisting member 10 combined with each other compared with when the solar cell panel 2 is bonded to the assisting member 10. Therefore, in the solar cell module, it is made possible to improve maintainability.

Note that the spacer 38 is not only compression-bonded to the assisting member 10 and the solar cell panel 2 with the repulsive force, but can be bonded to at least one of the assisting member 10 and the solar cell panel 2. In this case, by making it easy to peel off the bonded portion, maintainability for making it easy to remove the solar cell panel 2 and the assisting member 10 can be given to the spacer 38.

In the solar cell module in this embodiment, the assisting member 20 shown in FIG. 8 can be used instead of the assisting member 10 shown in FIG. 4. In the solar cell module, as in the second embodiment, the spacer 38 can be combined with the assisting member 33. The spacer 38 can be provided to cover the entire edge of the solar cell panel 2 so as to also play the function of the edge protector 32 (see FIG. 11).

### Fourth Embodiment

FIG. 14 is a side view of the configuration of an end of a holding member and the vicinity of the end in a solar cell module according to a fourth embodiment of the present invention. Components same as the components in the first embodiment are denoted by the same reference numerals and signs and redundant explanation of the components is omitted as appropriate.

An assisting member 40 includes, in a position opposed to the light receiving surface 2a of the solar cell panel 2, a protrusion section 41 projected to the light receiving surface 2a side. The protrusion section 41 is formed by sharpening the distal end thereof projected to the light receiving surface 2a side. The assisting member 40 has a configuration same as the configuration of the assisting member 10 (see FIG. 4) in the first embodiment except that the assisting member 40 includes the protrusion section 41. Like the assisting member 10, the assisting member 40 is fixed to be spaced apart from the light receiving surface 2a.

Only when the solar cell panel 2 peels off the holding member 3 because of some cause and stress in the direction separating from the holding member 3 acts on the solar cell panel 2, the assisting member 40 comes into contact with the light receiving surface 2a of the solar cell panel 2. The protrusion section 41 of the assisting member 40 comes into contact with the light receiving surface 2a first.

The stress applied to the light receiving surface 2a from the assisting member 40 concentrates on the protrusion section 41. This makes it possible to surely destroy the translucent panel 6 (see FIG. 2) of the solar cell panel 2 at a stage when pressure applied from the assisting member 40 is relatively small. When the holding member 3 is peeled from the rear surface 2b and large wind pressure is applied to the solar cell panel 2, the solar cell panel 2 is destroyed to be light and small pieces and falls before being blown off. Consequently, it is possible to suppress an adverse effect on the surroundings caused by the blow-off of the solar cell panel 2 before the coming-apart. When the solar cell module is set in a place where buildings are present in the neighborhood, for example, an urban area or a residential area, it is useful to destroy the solar cell panel 2 before the solar cell panel 2 comes off.

A solar power generation system including the solar cell module in this embodiment can include a monitoring system capable of quickly detecting abnormality according to the deterioration in the power generation efficiency due to breakage of the solar cell panel 2. Besides the configuration in which the protrusion section 41 is added to the assisting member 10 shown in FIG. 4, the assisting member 40 can have a configuration in which the protrusion section 41 is added to the assisting member 20 shown in FIG. 8 or the assisting member 33 shown in FIG. 12. In the solar cell module, the spacer 38 (see FIG. 13) can be provided instead of the bonding layer 17 between the assisting member 40 and the solar cell panel 2.

### Fifth Embodiment

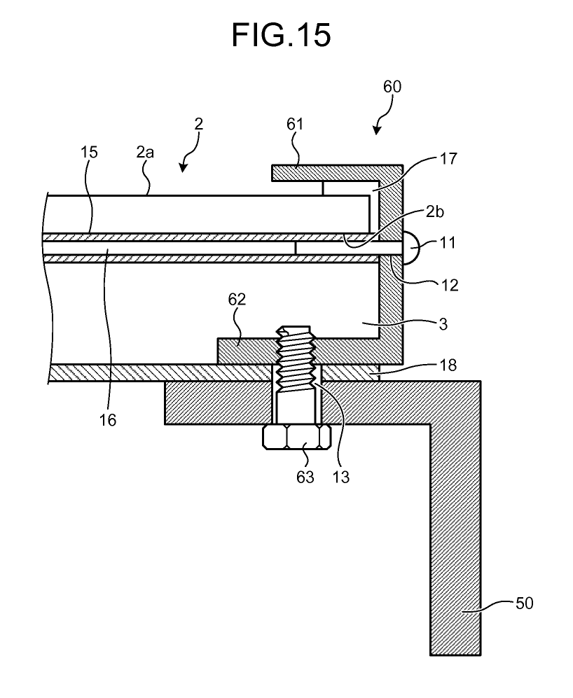

FIG. 15 is a sectional view of the configuration of an end of a holding member and the vicinity of the end in a solar cell module according to a fifth embodiment of the present invention. Components same as the components in the first embodiment are denoted by the same reference numerals and signs and redundant explanation of the components is omitted as appropriate.

An assisting member 60 is fixed to the end of the holding member 3 by the screw 11, which is a first fixing member. The assisting member 60 assists the holding of the solar cell panel 2 by the holding member 3. The bonding layer 17 bonds the assisting member 60 and the solar cell panel 2.

The assisting member 60 is formed in a bent shape with a plate material bent at a substantially right angle in two places. A first bent section 61 is a portion bent in a direction opposed to the light receiving surface 2a from the edge of the solar cell panel 2 in the assisting member 60. In the assisting member 60, the first bent section 61 and the light receiving surface 2a are fixed to be spaced apart from each other.

A second bent section 62 is a portion bent in a direction along a bottom surface section 18 on the opposite side of a side joined to the solar cell panel 2 in the holding member 3 from a portion fixed to the holding member 3 by the screw 11 in the assisting member 60.

The bolt hole 13 is formed in the bottom surface section 18 of the holding member 3. A bolt 63 for fixing the holding member 3 to the rack 50 that supports the solar cell panel 2 is inserted through the bolt hole 13. The bolt 63 is a second fixing member that collectively fixes the holding member 3 and the assisting member 60 to the rack 50.

The bolt 63 pierces through the rack 50 and the bolt hole 13 of the bottom surface section 18 in the holding member. In the second bent section 62, a tightening hole capable of tightening the distal end of the bolt 63 is formed. The distal end of the bolt 63 is tightened in the tightening hole of the second bent section 62, whereby the holding member 3 and the assisting member 60 are collectively fixed to the rack 50 by the bolt 63. As in the first embodiment, the solar cell module in this embodiment can be reduced in weight and can prevent a come-off of the solar cell panel 2.

According to this embodiment, in the solar cell module, because the tightening hole is provided in the second bent section 62, it is unnecessary to separately attach a nut for attaching the solar cell panel 2 to the rack 50. According to this embodiment, in the solar cell module, work for attaching the solar cell panel 2 to the rack 50 can be simplified compared with when the bolt 63 is tightened with the nut held in a position matching the bolt hole 13 on the inner side of the holding member 3. With the configuration in this embodiment, even when it is difficult to attach a member on the inner side of the holding member 3, there is no problem in work for attaching the solar cell panel 2. Therefore, in the solar cell module, design with a high degree of freedom is possible concerning a structure for fixing the solar cell panel 2.

As in the modification of the first embodiment, the first fixing member can be an inserting section formed by projecting a part of the assisting member 60. In the solar cell module, the spacer 38 (see FIG. 13) can be provided instead of the bonding layer 17. In the assisting member 60, the protrusion section 41 (see FIG. 14) can be provided at the distal end of the first bent section 61.

### Sixth Embodiment

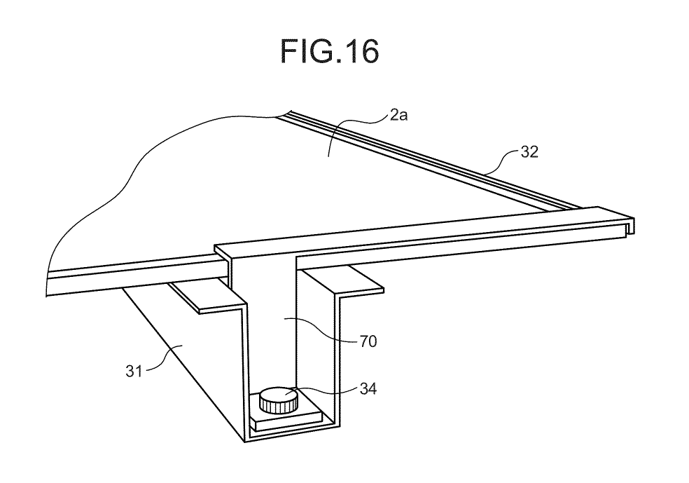

FIG. 16 is a perspective view of the configuration of an end of a holding member and the vicinity of the end in a solar cell module according to a sixth embodiment of the present invention. Components same as the components in the first and second embodiments are denoted by the same reference numerals and signs and redundant explanation of the components is omitted as appropriate.

An assisting member 70 is fixed to an end in the longitudinal direction of the holding member 31 in the holding member 31. The assisting member 70 assists the holding of the solar cell panel 2 by the holding member 31. The bolt 34 is a fixing member that fixes the assisting member 70 to the bottom surface section of the holding member 31. The assisting member 70 is bent to the edge 2c (see FIG. 3) of the solar cell panel 2 from a place fixed by the bolt 34.

The assisting member 70 is further bent in a direction opposed to the light receiving surface 2a from a portion erected to the light receiving surface 2a side through the edge 2c of the solar cell panel 2 from a position on the rear surface 2b side fixed to the holding member 31 by the bolt 34. In the solar cell module, the bonding layer 17 (see FIG. 7) that bonds the assisting member 70 and the edge protector 32 or the solar cell panel 2 can be provided. In the solar cell module, the spacer 38 (see FIG. 13) can be provided.

In the assisting member 70, a bent section bent in the direction opposed to the light receiving surface 2a is formed in a shape extended along a side of the rectangle of the solar cell panel 2. The bent section is extended from an attaching position where the assisting member 70 is attached to the holding member 31 within the rectangle of the solar cell panel 2 to a part of a second side perpendicular to a first side including the attaching position within the rectangle of the solar cell panel 2.

The assisting member 70 prevents a fall-off of the solar cell panel 2 when the solar cell panel 2 comes off the holding member 31. As in the first embodiment, the solar cell module in this embodiment can be reduced in weight and can prevent the fall-off of the solar cell panel 2. The assisting member 70 includes the bent section bent from the first side to the second side attached to the holding member 31. Therefore, the assisting member 70 can hold the solar cell panel 2 from the directions of the first side and the second side. According to this embodiment, the solar cell module can effectively prevent a fall-off of the solar cell panel 2 from the rack 50 (see FIG. 6).

Note that, in the assisting member 70, the protrusion section 41 (see FIG. 14) can be provided in the bent section. In the solar cell module, as in this embodiment, concerning the assisting member 10 shown in FIG. 4, the assisting member 20 shown in FIG. 8, and the assisting member 60 shown in FIG. 15, the bent section can be extended to a part of the second side.

### REFERENCE SIGNS LIST

1, 30 Solar cell modules
2 Solar cell panel
2a Light receiving surface
2b Rear surface
2c Edge
3, 31 Holding members
4 Terminal box
5 Solar cell
6 Translucent panel
7 Back film
8 Sealing material
10, 20, 33, 40, 60, 70 Assisting members
11 Screw
12, 16 Screw holes
13, 35 Bolt holes
14 Cutout section
15 Bonding surface
17 Bonding layer
18 Bottom surface section
21 Inserting sections
22 Insertion hole
32 Edge protector
34, 63 Bolts
38 Spacer
41 Protrusion section
50 Rack
61 First bent section
62 Second bent section

1. A solar cell module comprising:
a solar cell panel including a light receiving surface;
a rail-like holding member joined to a rear surface on the opposite side of the light receiving surface in the solar cell panel, the holding member reinforcing and holding the solar cell panel;
an assisting member fixed to an end in a longitudinal direction of the holding member within the holding member, the assisting member assisting the holding of the solar cell panel by the holding member; and
a fixing member that fixes the assisting member to the holding member, wherein
the assisting member has a bent shape bent in a direction opposed to the light receiving surface from a portion erected to the light receiving surface side through an edge of the solar panel from a position on the rear surface side fixed to the holding member by the fixing member.

2. The solar cell module according to claim 1, wherein
a screw hole into which a screw, which is the fixing member, is inserted is formed in the holding member, and
in the holding member, a cross section perpendicular to the longitudinal direction is formed in a same shape including a shape of the screw hole in all positions in the longitudinal direction.

3. The solar cell module according to claim 1, wherein
the fixing member is an inserting section within the assisting section, which is formed to be insertable into an insertion hole formed in the holding member, and
in the holding member, a cross section perpendicular to the longitudinal direction is formed in a same shape including the shape of the insertion hole in all positions in the longitudinal direction.

4. The solar cell module according to claim 1, wherein the fixing member collectively fixes the holding member and the assisting member to a rack that supports the solar cell module.

5. The solar cell module according to claim 1, wherein the assisting member is fixed to be spaced apart from the light receiving surface.

6. The solar cell module according to claim 5, further comprising a bonding layer that bonds the assisting member and the solar cell panel.

7. The solar cell module according to claim 5, wherein
a spacer is set between the assisting member and the solar cell panel, and
the spacer is formed of a material having high flexibility with respect to a translucent member, which forms the light receiving surface of the solar cell panel, and is provided to be compression-bonded to the assisting member and the solar cell panel.

8. The solar cell module according to claim 1, wherein a translucent member forming the light receiving surface of the solar cell panel is formed with a strength for allowing the solar cell panel to be destroyed by stress weaker than stress applied when the holding member is peeled from the rear surface and the solar cell panel comes off the assisting member.

9. The solar cell module according to claim 8, wherein the assisting member includes, in a position opposed to the light receiving surface, a protrusion section projected to the light receiving surface side.

10. The solar cell module according to claim 1, further comprising:
a first fixing member, which is the fixing member that fixes the assisting member to the holding member; and
a second fixing member that collectively fixes the holding member and the assisting member to a rack that supports the solar cell module, wherein
the assisting member includes a bent section bent, from a portion fixed to the holding member by the first fixing member, to be capable of being joined to a bottom surface section on the opposite side of a side joined to the solar cell panel within the holding member, and
in the bent section, a tightening hole capable of tightening a distal end of the second fixing member, which pierces through the rack and the bottom surface section of the holding member, is formed.

11. The solar cell module according to claim 1, wherein
an external shape of the solar cell panel is formed in a rectangular shape, and
a bent section bent in a direction opposed to the light receiving surface is extended from an attaching position where the assisting member is attached to the holding member within the rectangle to a part of a second side perpendicular to a first side including the attaching position within the rectangle.
